(19) United States
(12) Patent Application Publication
(10) Pub. No.: US 2005/0146869 A1
(43) Pub. Date: Jul. 7, 2005

(54) Lighting device on computer panel

(76) Inventor: Sen Lee, Panchiao City (TW)

Correspondence Address: TROXELL LAW OFFICE PLLC, SUITE 1404, 5205 LEESBURG PIKE, FALLS CHURCH, VA, 22041, US

(21) Appl. No.: 10/752,031

(22) Filed: Jan. 7, 2004

(51) Int. Cl. F21S 2/00

(52) U.S. Cl. 362/227

(57) ABSTRACT

A lighting device for the computer panel, having variations of flashing light emitting from LED units; wherein a circuit board with layout of LED units is installed on a rear side of a computer panel, whereby LED light is projected through a translucent acrylic board that is installed on a matching panel, to show flashing and lighting variations according to commands programmed in a chip on the circuit board.

### FIELD OF THE INVENTION

The exterior appearance of a computer set is an important factor for a consumer to decide whether or not to buy the product. Conventionally, computer manufacturers would place an emphasis on the research and development of exterior computer styling, particularly on the configuration and features of computer panels. The present invention integrates such features as energy saving, high illumination, color combinations and flashing LED units into the computer set, creating special visual effects to the panels.

The present lighting device invention for computer panel has included the features of LED effects by attaching a circuit board of LED units on the rear side of a computer panel, so the LED light source produces variable flashing and lighting patterns according to commands programmed in a chip on the circuit board, enhancing visual effects to the computer set.

### DESCRIPTION OF THE PRIOR ART

Operating functions and shiny exterior of a computer set are the main attractions to prospective computer purchasers. When different models have similar functions, the first impression provided by the computer exterior and its visual effects will become the only important reason for purchasing the particular model. In the development of new computer models, manufacturers would focus on the styles and color variations on the computer panels, trying to attract prospective buyers. No matter how their exterior configurations can change, consumers often find them almost the same.

The present inventor has devoted in the design of a computer set or panel that gives lighting source and changing colors, even with the integration of sound and lighting to catch the consumers' attention.

### SUMMARY OF THE INVENTION

Please refer to FIG. 1 showing a perspective view, and FIG. 2 showing a perspective embodiment view of the present invention of lighting device on the computer panel, wherein, a circuit board (1) carrying LED units (11) is fastened by screws (12) onto a rear side of a computer panel (3) housing a computer main unit (2), and a translucent acrylic board (31) is mounted on a position on the computer panel (3) to match the position where the circuit board (1) and the LED units (11) are located.

Installed on the circuit board (1) carrying the LED units (11) is a programmed chip (not shown in drawing), giving commands to light and flash on the LED units (11) in a sequential order, while the quantity, color and distribution of the LED units (11) are not defined.

Installed on the circuit board (1) is a power connector (13) connecting with a connector terminal (41) at one end of the power cord (4), the other end of the power cord (4) is connected to a power supply.

Thereby, when the computer main unit (2) is switched on, the chip on the circuit board (1) gives programmed commands to light and flash on the LED units 11 in orderly variations, projecting shiny and varied lighting patterns.

### DESCRIPTION OF THE PREFERRED EMBODIMENT

FIG. 3 shows a perspective view of another embodiment of the present invention, wherein, a circuit board (1) carrying LED units (11) is attached to an open-door computer panel (5) equipped with a revolving door (51) to obtain the same lighting effects as described above.

### BRIEF DESCRIPTION OF DRAWINGS

FIG. 1 is a perspective view of the present invention of lighting device on computer panel.

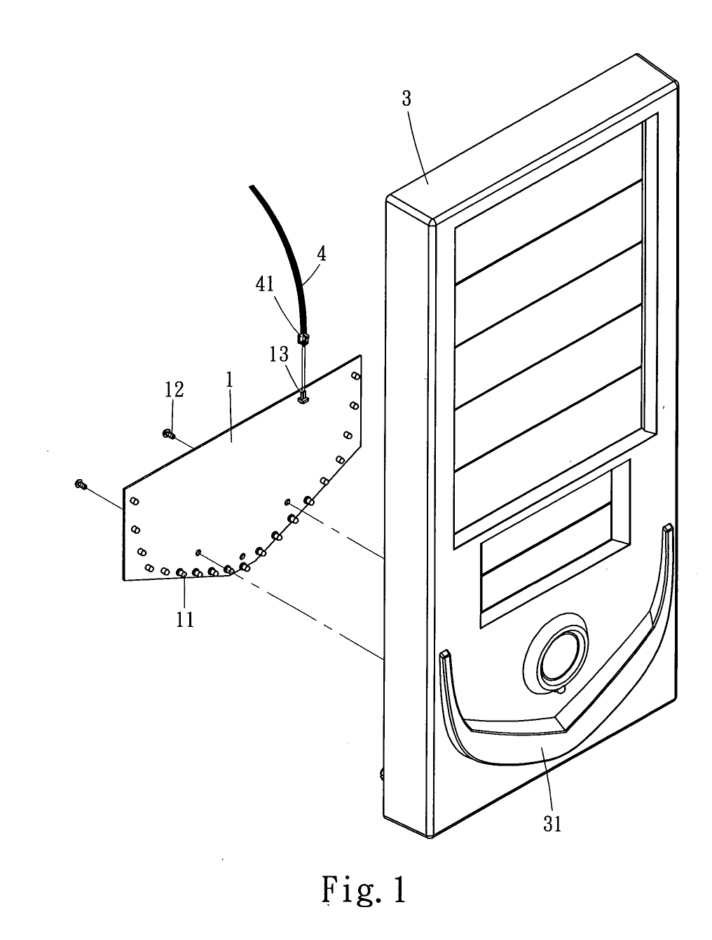

FIG. 2 is a perspective embodiment view of the lighting device on the computer panel.

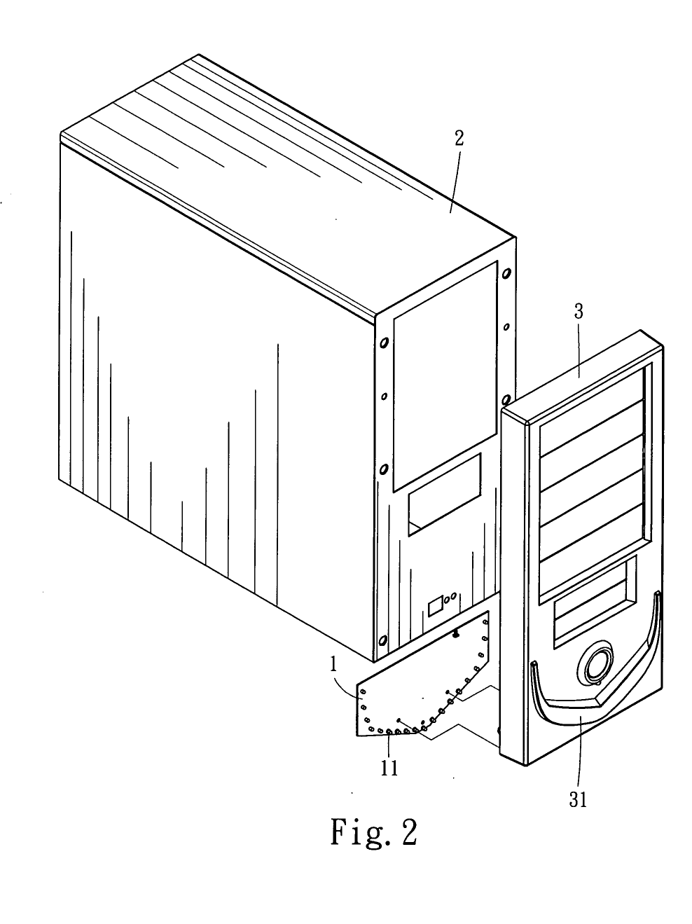

FIG. 3 is a perspective embodiment view of the present invention.

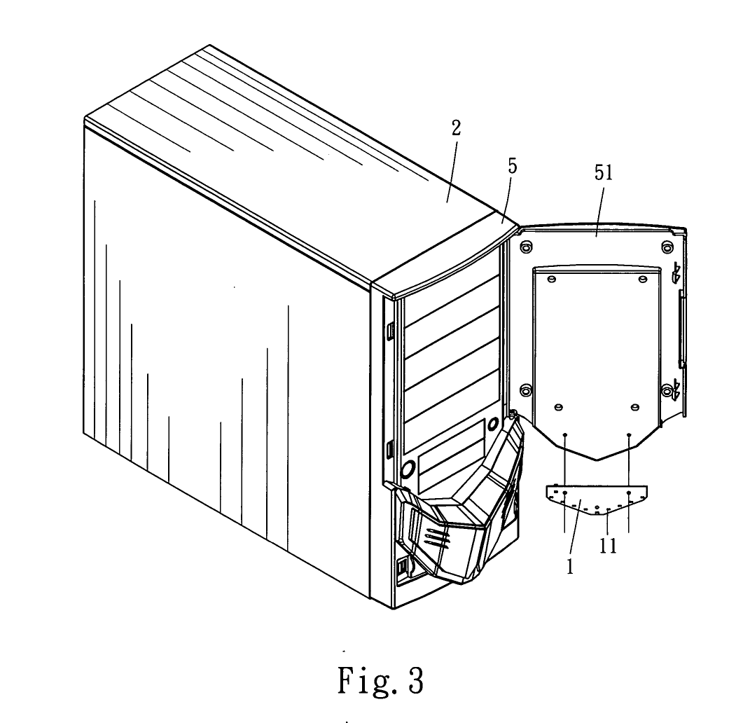

1. A lighting device for computer panel, comprising a circuit board carrying LED units thereon, the circuit board being attached by screws onto the rear side of a computer panel, and a translucent acrylic board attached to a position on the computer panel to match the position where the circuit board and the LED units are located, the circuit board having a programmed chip to light and flash on the LED units according to commands programmed in the chip.

2. The lighting device for the computer panel of claim 1, wherein the quantity, colors and distribution of the LED units on the circuit board are not defined.

3. The lighting device for the computer panel of claim 1, wherein the circuit board has a power connector that is connected to a connector terminal at one end of a power cord, the other end of the power cord is connected to a power supply.

4. The lighting device for the computer panel of claim 1, wherein the circuit board carrying the LED units is optionally attached to a computer panel mounted with a revolving door to obtain the same lighting effects.
